(19) United States
(12) Patent Application Publication
(10) Pub. No.: US 2020/0148557 A1
(43) Pub. Date: May 14, 2020

(54) method to control micro algae growth and mitigation of microcystins

(71) Applicant: Shoudong Fang, Shenzhen (CN)

(72) Inventor: Shoudong Fang, Shenzhen (CN)

(21) Appl. No.: 16/199,111

(22) Filed: Nov. 23, 2018

(30) Foreign Application Priority Data
Nov. 13, 2018 (CN) 201811346231.2

(51) Int. Cl. C02F 1/32; C02F 1/36

(52) U.S. Cl. CPC C02F 1/32; C02F 2103/007; C02F 1/36

(57) ABSTRACT

The invention discloses a method to control micro algae growth and mitigation of microcystins, including the installation of algae control unit, algae control unit including metal drainage pipe and several charging chambers along the metal drainage pipe, one or more pairs of transmitters and receivers are installed in these charging chambers, electromagnetic waves are transmitted through water, the high energy point in these charging chambers are grounded through metal, generating high energy gradient electromagnetic wave in charging chambers, the invention uses repeatable high energy gradient intermittent shock treatment, which can provide more effective treatment for phytoplankton and other organisms, especially in freshwater environment, which can improve the killing effect of phytoplankton, and uses high gradient near-field ionic current to destroy the molecular structure of microcystins, especially benzene ring and O—H and N—H hydrogen bonds, compared with the existing treatment method, the invention can effectively solve microcystins problem.

### FIELD OF THE INVENTION

The present invention belongs to the field of algae control technique, more particularly, to a method to control micro algae growth and mitigation of microcystins.

### BACKGROUND OF THE INVENTION

This invention is for treatment of microcystins and algae control in natural or artificially created reservoirs, lakes, rivers, cannel, streams, ponds, pools, seafronts etc. In particular for water resources which are meant for human consumption.

For these freshwater resources, they are getting more fragile nowadays due to the increasing human activities which introduce more nutrient into the water system. Global climate change also increases the frequency of sudden changes alternate between heavy rainfalls and sunshine hence more runoff and nutrient going into the stagnant areas. More intense sunshine also causing sudden rise in water temperature hence the unusual frequency of algae bloom in many areas. These situations are even more severe in places where river mouth are blocked and converted the river into water reservoirs.

When there is algae bloom in these drinking freshwater resources, it has serious health impact on the human when consuming water from such resources. One of these issues is the toxin substances in the water and/or released from the dead algae or bio-organisms. In particular the Microcystins, a toxin to human liver released by the micro algae, cyanobacteria or blue green algae.

Algae has many species and sizes present in the water ways and it may be classed loosely by their sizes which is >50 um and <50 um size. The larger than 50 um size algae in generally can be solved by using efficient filtration method to remove them, but the more difficult part is the removal of the <50 um size algae which is inefficient to be removed by mechanical filtration system effectively. Cyanobacteria of 0.5 to 40 um size falls under the <50 um category and they are known to release the microcystins from their cell when it is lysed or dead.

To simply kill the algae or phytoplankton of <50 um, it can be achieved by many methods available in the market. However, for water to be able to use for human consumptions the following prerequisites are needed;
1) It must not further produce more toxic substances during or after the treatment process. In particular, the microcystins shall be reduced after the treatment and preferably to meet the WHO drinking water requirement of <1 ppb.
In conventional algae treatment, Microcystins are generally increase in water after the microalgae are killed. Cyanobacteria microcystins are formed and contained within the cells in general when the cell is alive, but most of the microcystins toxin cell contents will be released once the cells are killed or lysed. If microcystins level is high in the original water source and since there is no process in drinking water treatment to remove microcystins, the microcystins level usually maintain the same as the original water source level or become higher after treatment and unable to meet the WHO drinking water standard.
2) Since microcystins in freshwater are mainly contributed by cyanobacteria, so another way to reduce the microcystins is to ensure effective killing or control the growth of phytoplankton of less than 50 um size.
3) There must be good residual effect in controlling the regrowth of the algae after treatment.
4) To ensure the entire ecological food chain within a reservoir freshwater system is not upset by this treatment, the kill method must not kill other desirable/beneficial organisms in the ecological system.
5) There must not be other toxic or hazardous chemical introduced or generated in the treatment process as it will further contaminate the water source and upset the ecological system of the water source.
6) It must be able to treat in low electrical conductivity freshwater, estuary and high conductivity seawater as well as low chloride content such as freshwater reservoir.

Presently Available Treatment Methods.

The present available treatment methods for micro algae available in the market may be classified in the following;
1) Chemical Dosing Treatment Methods—
These methods include the dosing of Hydrogen peroxide H2O2, chlorine, chlorine dioxide, CuSO4, and other algaecides.
Since the water is for human consumption, chemical treatment is undesirable especially the hazardous or toxic chemicals
For the chemicals to have the algaecidal effect, generally they are either the strong oxidizing or toxic agent. Certainly toxic agent is not allowed if the water source is for drinking water purpose. If it is strong oxidizing agent, then the effective kill concentration must be maintained in the water during the treatment yet after the treatment, the TRO and TRC of the water must be brought down by addition of more chemicals to a level that is not harmful to the environment and not upsetting the ecological system. But these additional chemicals added are degrading the water quality and upset the ecological balance of the water sources. Introducing chemicals directly into the water sources also increases the health risks when consumed by human.
But most important in all these treatments, these methods do not destroy or reduce microcystins and in fact all these methods cannot control the release of microcystins when the cyanobacteria are killed or lysed. Hence it is still unable to solve the drinking water requirement.
In view of these constraints, chemical methods are not suitable for control of algae in the open source areas such as reservoir, rivers, etc. In the open area such as reservoirs, rivers, etc.
2) Electrolysis Method
Conventionally it utilizes the DC current to generate oxidizing agents such as hypochlorite, hydrogen peroxide, hydrogen oxide radicals to kill the organisms. But the low electrical conductivity and low chloride content making the DC electrolysis inefficient in generating the required amount of current and disinfectants. Even if the disinfectants may be compensated by huge amount of power, the disinfectants after the treatment will kill other desirable organisms in the water and upset the ecological system. Similarly, DC electrolysis is unable to solve the microcystins issue.
3) Physical Methods
There are many physical methods available to treat algae such as UV, ultrasounds, cavitation, pulsating time varying electromagnetic wave with or without DC imposition, etc. In these methods, generally they have the shortcomings in the following;
   High energy consumption for UV, ultrasound and cavitation methods.
   Fouling of the UV lamps.
   High interference between ultrasound generators.
   UV, Ultrasound and cavitation are only good at the point of treatment but no residual effect in controlling the re-growth.
   All methods are unable to reduce microcystins.
   In all the above physical methods for drinking freshwater algae control, none of these physical methods has all round capabilities in meeting all the drinking freshwater algae control requirement.
      UV
      UV is known to have the disadvantages of high power consumption and fouling of lamps or unable to perform in turbid water. U V is also known to be effective only at the point of treatment and it does not have the residual effect. Without the residual effect, it is impossible to treat the reservoir water in an open field condition as algae will continue to grow in the treated water after the UV treatment.
      When UV is used for algae treatment, the algae “killed” definition will determine the UV power requirement. Based on MPN (Most Probable Number) count method, the power consumption is already known to be very high and if it is based on FDA/CMFDA method which defines “killed” as all metabolic activities of the algae cell are ceased. Then the power consumption will be 4 times higher than the MPN count method. That is per 100 cu·m/hr flow rate will need about 30˜50 kw of UV power.
      Yet the most critical issue with UV is the inability to control the release of toxic microcystins. When algae cells are killed by the UV, the microcystin contained within the cell membrane is released to the water. As a result, microcystins count increases in water instead of reduced after treatment.
      Ultrasound/Cavitation
      Ultrasound and Cavitation are mechanical means of killing the algae cell. With Ultrasound, interference between the ultrasound waves/generators is the common issue when applying to large scale treatment and high power consumption is another issue.
      Lack of residual effect and inability to control the metabolic activities of the algae cell is the other typical issues with mechanical means of treating algae.
      Yet another issue with mechanical means of control algae is the treatment only able to break the cell wall but it is unable to break any molecular bond hence unable to reduce microcystins. The same issue of microcystins leaking through the cell wall into the water is another reason for not being able to apply in freshwater water algae microcystin reduction.
      DC Bias Time Varying Pulsating Wave
      Such method may be used for treatment for algae but it is primarily meant for marine ballast water treatment to meet IMO requirement instead of for human drinking water consumption purpose. Marine ballast seawater has high conductivity hence it is able to generate the required ionic current strength. The high chloride content of seawater also allowing the DC component of the wave to perform the function of DC electrolysis of seawater to produce the needed disinfectants. However, in drinking freshwater water source, the water conductivity is as low as 100 us/cm comparing with 50,000 us/cm for seawater, it is difficult to produce the needed ionic current and the disinfectant hence inefficient in drinking freshwater water source treatment. For this reason, UV is added in the ballast water application to increase the kill rate. In addition, ballast water is stored in the ballast tank without sunlight for many days in the treatment process, algae cells are therefore died off naturally due to lack of sunlight. In drinking water open air reservoir, sunlight which promotes algae growth is available hence this time varying prior art method is not suitable for algae treatment in drinking freshwater open reservoir.
      In addition, for drinking water reservoir application, control of less than 10 um cyanobacteria microalgae treatment and to reduce or remove toxic microcystins are most critical. Prior art is silent about the treatment of microcystins and the treatment of less than 10 um microalgae (cyanobacteria). These two pre-requisites are most important in treatment of drinking water source hence prior art is also unable to fulfil such requirement especially for reservoir collecting rain water.
      In prior art, it lacks the feature of adequate fast grounding process to kill the phytoplankton effectively. In prior art, it only creates an energized condition for the organism. This is similar to standing on high voltage cable without ground hence lacking the kill effect. In this invention, a fast grounding feature is incorporated in at least one of the intermittent treatment stage to effective kill the organisms.
      Among all the issues above, the most difficult issue to resolve is the reduction in microcystins, and with the constraint of without using any chemicals. The next issue is the ability to kill the algae in the low conductivity and low chloride content freshwater environment yet must have the residual effect to control the regrowth of algae and without harming the eco system.
      In all the treatment methods available in the market and without addition of other chemicals, when the phytoplankton cell is lysed or dead, the microcystins structure remains intact and either leaked through the membrane or directly going into water. So far no effective microcystin treatment method especially for drinking freshwater is available.

### SUMMARY OF THE INVENTION

To solve the above technical problems, the technical proposal of the invention is: a method to control micro algae growth and mitigation of microcystins, including the following steps:
1) Set up algae control unit (ACU), algae control unit including metal drainage pipe and several charging chambers along the metal drainage pipe, One or more pairs of transmitters and receivers are installed in these charging chambers, Electromagnetic waves are transmitted through water.
2) The high energy point in the charging room is connected to the ground through metal, resulting in a high energy gradient in the charging chamber.
3) The transmitter/receiver voltage difference shall not be less than 24V, Such potential applied across the transmitter/receivers spacing must not be more than 10 cm, the current density between the transmitter/receiver pairs must not be less than 1 amps/sq·m.
4) The water that needs to be treated is introduced into the ACU for treatment. Using high gradient potential close field ionic current to break the microcystins molecular structures in particular the benzene ring and O—H and N—H hydrogen bonds. Vibrates the water hydrogen bonding to interrupt electrons/charge flow in water to further disrupt the cell metabolic pathway or process. Using high gradient potential close field ionic current to burst chlorophyll including fast grounding technique.
5) Using proximity method, The problem of low conductivity and low chloride content is solved by close field high current density and high voltage gradient method.
6) For low conductivity fresh water, intermittent electromagnetic pulse treatment is carried out with less than 1 MHz of pulsating electromagnetic wave. Using intermittent shock treatment to increase the kill efficacy for phytoplankton.
7) The equipment of this invention is mounted on the amphibian vehicle or motorized/non-motorized barge. The vehicle or the barge is then moved to the algae infested hot spot area and station at that affected area for treatment. There may be other treatment arrangement such as mounting the equipment onshore and direction the water to the treatment station onshore before discharging it back into the water. Algae blooms can also be segmented. Algae-infested water can be recycled in a small area of the region for multi-stage or cyclic treatment.
Preferably, the charging chamber is a 1 MHz pulsed electromagnetic wave charging chamber, which comprises a non-metallic inner chamber and a non-conductive material lining arranged in the non-metallic inner chamber.
Preferably, the transmitter/receiver voltage difference is 60V.
Preferably, the transmitter/receivers spacing is less than 5 mm.
Preferably, the current density between the transmitter/receiver pairs is more than 10 amps/sq·m.

The invention provides a method for controlling algal growth and mitigation of microcystins, The main focus of this invention is to resolve the mitigation or removal of microcystins increase issues. In nature, There are many types of microcystins and the following microcystin-LR is the most common and typical.

In the microcystin molecular structure, there are benzene rings, O—H and N—H hydrogen bonds in the molecules. Due to the polar nature of hydrogen bond and the 6 pi electrons (two for each pi bond) of the benzene ring, these bonds are susceptible to the electromagnetic wave. More particularly, it is very susceptible to electrophile attack when the electromagnetic wave is pulsating.

Since the microcystins are present in the water, if pulsating electromagnetic wave is used, such pulsating electromagnetic wave must resonate with the water molecule especially the water hydrogen bond in order to store and transmit the energy. This storage of vibration energy in water is essential to create the residual treatment effect ensuring no regrowth of algae in the treated water.

In thermal heating, heat energy is dispensed into the water and used to increase the water molecular movement and to some extend stretches or compresses the water hydrogen bond. The heat energy is stored and dissipate gradually to the lower temperature environment.

With the pulsating electromagnetic wave, at frequency range of less than 1 MHz, either in time varying or non-time varying, it will stretch or compress the hydrogen bond. While correct frequency of non-pulsating electromagnetic waves do have the effect of stretching and compressing the hydrogen bond, pulsating time varying wave is much more effective in this aspect.

As a result of stretching or compressing of hydrogen bond, the O—H bond of water molecule will be vibrated and this can be detected and evidenced by the dynamic fluctuation in O—H peak in FTIR curve. It is also evident from the FTIR O—H peak fluctuation which showed that such peak fluctuation can be stored in the water for a long period of time.

Since water molecules hydrogen bond is susceptible to pulsating electromagnetic wave of less than 1 MHz, and water is able to carry such energy for a long period of time, this energy can be effectively carried by water molecules to reach and release the energy to the microcystins in water. Similar to heating in which energy is transferred from high to low temperature, for pulsating electromagnetic wave, instead of enthalpy (heat) input, it is by entropy input into the water. The pulsating electromagnetic wave transfers the energy to the water and excite the water O—H vibration energy as shown in the FTIR curve and elevated the water entropy energy. The rate of release or dissipation of this high entropy energy to surrounding is independent from temperature and it can be transferred between the same temperature regions as long as their entropy energy levels are different. If microcystins is directly exposed to the pulsating electromagnetic wave close field, the O—H, N—H hydrogen bond and the benzene ring of the microcystins will be broken or reoriented depending on the strength, the frequency range, sweeping frequency of the electromagnetic wave.

The invention uses a repeatable high energy gradient intermittent shock treatment, using the sudden change of energy gradient method which is from high energy charging directly to immediate grounding concept. It can provide more effective treatment for phytoplankton and other organisms, especially in freshwater environment. Intermittent shock treatment can improve the killing effect of phytoplankton. By using high gradient close field ionic current to destroy the molecular structure of microcystins, especially benzene ring and O—H and N—H hydrogen bonds, the invention can effectively solve the problem of microcystins compared with the existing treatment methods. Each step is a repeatable high energy gradient intermittent shock treatment, the number of repetitions is not the maximum limit, according to the needs of the processing target.

### BRIEF DESCRIPTION OF THE DRAWINGS

Description of FIGURES:

FIG. 1 is the schematic diagram of the algae control unit in this patent, a method to control micro algae growth and mitigation of microcystins.

1. charging chamber 2. Metallic drainage path

### DETAILED DESCRIPTION OF THE PREFERRED EMBODIMENT

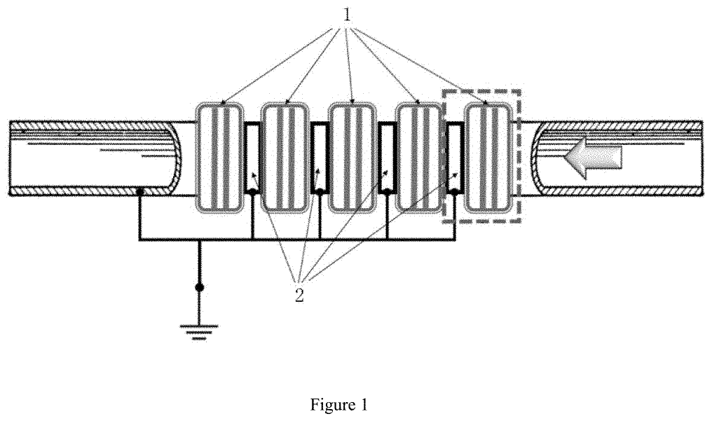

In conjunction with FIG. 1:

a method to control micro algae growth and mitigation of microcystins, include the following steps:

1) set up algae control unit (ACU), algae control unit including metal drainage pipe and several charging chambers along the metal drainage pipe, One or more pairs of transmitters and receivers are installed in these charging chambers, Electromagnetic waves are transmitted through water;

2) the high energy point in these charging chambers are grounded through metal, generating high energy gradient electromagnetic wave in charging chamber;

3) the transmitter/receiver voltage difference shall not be less than 24V, Such potential applied across the transmitter/receivers spacing must not be more than 10 cm, the current density between the transmitter/receiver pairs must not be less than 1 amps/sq·m;

4) the water that needs to be treated is introduced into the cyanobacteria controller for processing. The molecular structure of microcystins, especially benzene ring and O—H and N—H hydrogen bonds, was destroyed by high-gradient near-field ionic current. Vibration of water hydrogen bonds interrupted the flow of electrons/charges in water to further destroy cell metabolic pathways or processes. The high gradient potential near field ion current is used to rapidly crush chlorophyll;

5) using proximity method, Near-field high current density and high voltage gradient method are used to solve the problems of low electrical conductivity and low chloride content;

6) for low conductivity fresh water, intermittent electromagnetic pulse treatment is carried out with less than 1 MHz of pulsating electromagnetic Wave. Using intermittent shock treatment to increase the kill efficacy for phytoplankton;

7) the equipment of this invention is mounted on the amphibian vehicle or motorized/non-motorized barge. The vehicle or the barge is then moved to the algae infested hot spot area and station at that affected area for treatment. There may be other treatment arrangement such as mounting the equipment onshore and direction the water to the treatment station onshore before discharging it back into the water. Algae blooms can also be segmented. Algae-infested water can be recycled in a small area of the region for multi-stage or cyclic treatment. All these other arrangements can be varied according to the site requirement and constraint but the main treatment equipment and the principle of treatment concept remains the same.

In lab test result after prolonged treatment

| | | | Sample Date: 22 Mar. 2018 | |
|---|---|---|---|---|
| | | | Initial | Treated |
| Test Parameter | Unit | Test Method | Ave 7 | Ave 7 |
| Chlorophyll-a | mg/m³ | APHA 10200H | 693 | 1.30 |
| | | (2) | | |
| Microcystin | ppb | Microcystins | 33.2 | 0.15 |
| | | Tube Kit | | |

Note:

1. APHA is a standard method for Determination of Water and Waste Water (APHA 22^{nd} Edition, 2012)

2. “<”=Less than. The data reported is less than Detection Limit of the test.

On site reservoir test also showed that

| | Microcystins | Microcystin |
|---|---|---|
| One pass test | Untreated (ug/L) | Treated (ug/L) |
| Test 1 Open site mesocosm | 2.32 | 0.85 |
| Low concentration | | |
| Test 2 Open site mesocosm | 9.08 | 5.76 |
| higher concentration | | |

In tank test

| One pass in tank test | | Microcystin |
|---|---|---|
| One Pass Treatment | Untreated Water | 4.96 |
| | Treated Water Discharge | 2.02 |

The above is the one pass treatment result, and further reduction can be achieved with repeated steps treatment.

In open field treatment, multi-stage treatment is preferred, or algae blooms are separated and isolated from other large amounts of water. Algae typically live in water up do depth of about 1.5 m from surface, and a separation curtain extending about 2 meters from the surface will be sufficient to isolate algae. The water infested by algae can be recycled or recycled in a small area after partitioning.

Other treatment methods, such as hot spot treatment, can also be used to install the algae control unit of the invention on an amphibious vehicle or a motor/non-motor barge, and then move the vehicle or barge to the hot spot area and station where algae infects the affected area for treatment.

The algae control unit in the invention can be installed on the shore and a treatment station can be set up to extract or guide algae-infected water to the treatment station on the shore for treatment and discharge back into the water. The use of the present invention can vary according to specific requirements, but the algae control unit and the treatment principle of the main treatment equipment in the present invention remain unchanged.

The present invention and its embodiments are described above. This description is not limited, and the actual structure is not limited to it. In a word, if ordinary technicians in the field are inspired by it, without departing from the purpose of the invention, and without creative design of embodiments similar to the technical scheme, they shall all fall within the scope of protection of the present invention.

1. A method to control micro algae growth and mitigation of microcystins, comprising the following steps:
1) set up algae control unit (ACU), algae control unit including metal drainage pipe and several charging chambers along the metal drainage pipe, One or more pairs of transmitters and receivers are installed in these charging chambers, Electromagnetic waves are transmitted through water;
2) the high energy point in these charging chambers are grounded through metal, generating high energy gradient electromagnetic wave in charging chamber;
3) the transmitter/receiver voltage difference shall not be less than 24V, Such potential applied across the transmitter/receivers spacing must not be more than 10 cm, the current density between the transmitter/receiver pairs must not be less than 1 amps/sq·m;
4) the water that needs to be treated is introduced into the cyanobacteria controller for processing. The molecular structure of microcystins, especially benzene ring and O—H and N—H hydrogen bonds, was destroyed by high-gradient near-field ionic current. Vibration of water hydrogen bonds interrupted the flow of electrons/charges in water to further destroy cell metabolic pathways or processes. The high gradient potential near field ion current is used to rapidly crush chlorophyll;
5) using proximity method, Near-field high current density and high voltage gradient method are used to solve the problems of low electrical conductivity and low chloride content;
6) for low conductivity fresh water, intermittent electromagnetic pulse treatment is carried out with less than 1 MHz of pulsating electromagnetic wave. Using intermittent shock treatment to increase the kill efficacy for phytoplankton;
7) the equipment of this invention is mounted on the amphibian vehicle or motorized/non-motorized barge. The vehicle or the barge is then moved to the algae infested hot spot area and station at that affected area for treatment. There may be other treatment arrangement such as mounting the equipment onshore and direction the water to the treatment station onshore before discharging it back into the water. Algae blooms can also be segmented. Algae-infested water can be recycled in a small area of the region for multi-stage or cyclic treatment. All these other arrangements can be varied according to the site requirement and constraint but the main treatment equipment and the principle of treatment concept remains the same.

2. A method to control micro algae growth and mitigation of microcystins of claim 1, is characterized by charging chambers of 1 MHz pulsed electromagnetic wave, comprising non-metallic inner chambers and non-conductive material lining arranged in non-metallic inner chambers.

3. A method to control micro algae growth and mitigation of microcystins of claim 1, is characterized by the voltage difference of 60V between the transmitter and the receiver.

4. A method to control micro algae growth and mitigation of microcystins of claim 1, is characterized by the spacing between the transmitter and receiver is less than 5 mm.

5. A method to control micro algae growth and mitigation of microcystins of claim 1, is characterized by the current density between the transmitter/receiver pairs is more than 10 amp s/sq·m.
